(19) United States
(12) Patent Application Publication
(10) Pub. No.: US 2012/0328928 A1
(43) Pub. Date: Dec. 27, 2012

(54) BATTERY COOLING STRUCTURE OF VEHICLE

(75) Inventors: Se Min Oh, Suwon (KR); Sang Jun Kim, Paju (KR)

(73) Assignees: KIA MOTORS CORPORATION, Seoul (KR); HYUNDAI MOTOR COMPANY, Seoul (KR)

(21) Appl. No.: 13/312,958

(22) Filed: Dec. 6, 2011

(30) Foreign Application Priority Data
Jun. 22, 2011 (KR) 10-2011-0060525

(51) Int. Cl. H01M 10/50

(52) U.S. Cl. 429/120

(57) ABSTRACT

A battery cooling structure of a vehicle. The battery cooling structure realizes uniform cooling performance compared to a conventional technique because a plurality of battery modules constituting one battery pack are sequentially cooled by cooling air which passes from one side to the other side of the cooling structure in separate ducting units, thereby improving the operational performance and durability of the battery pack.

### CROSS-REFERENCE TO RELATED APPLICATIONS

This application claims under 35 U.S.C. §119(a) priority to Korean Application No. 10-2011-0060525, filed on Jun. 22, 2011, the disclosure of which is incorporated herein by reference in its entirety.

### BACKGROUND OF THE INVENTION

1. Field of the Invention

The present invention relates, in general, to a battery cooling structure of a vehicle and, more particularly, to a technique of cooling a battery module having a plurality of battery cells equipped in a vehicle, such as an electric vehicle.

2. Description of the Related Art

Generally, a battery pack provided in an electric or hybrid vehicle is configured in such a way that one battery module is formed of a plurality of battery cells and one battery pack is formed of a plurality of battery modules. One important technique related to the battery pack is that the respective battery modules constituting the battery pack and the respective battery cells constituting each battery module must cool evenly.

FIG. 1 is a view illustrating a conventional battery pack cooling structure. As shown in the drawing, the conventional battery pack cooling structure is configured in such a way that first to fourth battery modules are sequentially arranged to form a battery pack and air for cooling the battery pack is introduced through a suction duct 500 provided in a first side of the structure, and the cooling air introduced through the suction duct 500 cools the battery pack while sequentially passing through the first to fourth battery modules, and is, thereafter, discharged to the atmosphere through an exhaust duct 502 placed in a second side of the structure. To realize the forced circulation of cooling air in the cooling structure, a blower 504 is provided in the outlet of the exhaust duct 502, thereby discharging the cooling air which has taken on heat from the battery modules.

In the above-mentioned conventional battery cooling structure, the first battery module may be efficiently cooled to a desired level by cool air which has been just introduced thereto from the atmosphere. However, the second battery module, the third battery module and the fourth battery module are sequentially arranged after the first battery module as described above and are sequentially cooled by the air, so that, when the air reaches the fourth battery module, the temperature of the air has already risen due to heat absorption/exchange between the prior modules and the air and thus, may fail to efficiently cool the fourth battery module. The difference in battery cooling performance between parts deteriorates the operational performance of the battery pack and reduces the durability of the battery pack.

### SUMMARY OF THE INVENTION

Accordingly, the present invention has been made keeping in mind the above problems occurring in the related art, and the present invention is intended to propose a battery cooling structure of a vehicle, which can realize uniform cooling performance compared to the conventional technique which cools a plurality of battery modules constituting one battery pack that are sequentially cooled by cooling air that simply passes from one side to the other of the cooling structure, thereby improving the operational performance of the battery pack and improving the durability of the battery pack.

In order to achieve the above object, according to one aspect of the present invention, there is provided a battery cooling structure of a vehicle which has a first module group and a second module group arranged in a sequential row between an inlet and an outlet and each include at least one battery module, the first module group being located relatively close to the inlet and the second module group being located relatively close to the outlet; a first duct arranged to guide air, which has flowed from the inlet and has passed through the first module group while cooling the first module group, to the outlet after bypassing the second module group; and a second duct arranged to guide air, which has flowed from the inlet and has bypassed the first module group, to the second module group so that the air traveling through the second duct can pass through the second module group to cool the second module group without being affected by the heat generated by the first module group.

In another aspect of the present invention, there is provided a battery cooling structure of a vehicle, including: a plurality of battery modules arranged in sequential rows between an inlet and an outlet; and at least two divided ducts provided for guiding air flowing from the inlet in such a way that the air can pass through one part of the plurality of battery modules while cooling them and bypasses another part of the battery modules to reach the outlet.

The battery cooling structure of the vehicle according to the present invention is advantageous in that it can realize uniform cooling performance compared to the conventional technique in which a plurality of battery modules constituting one battery pack (i.e., one battery module group) are sequentially cooled by cooling air simply passing from one side to the other side of the cooling structure, so that the present invention is able to improve the operational performance and durability of the battery pack.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating a conventional battery cooling structure of a vehicle;

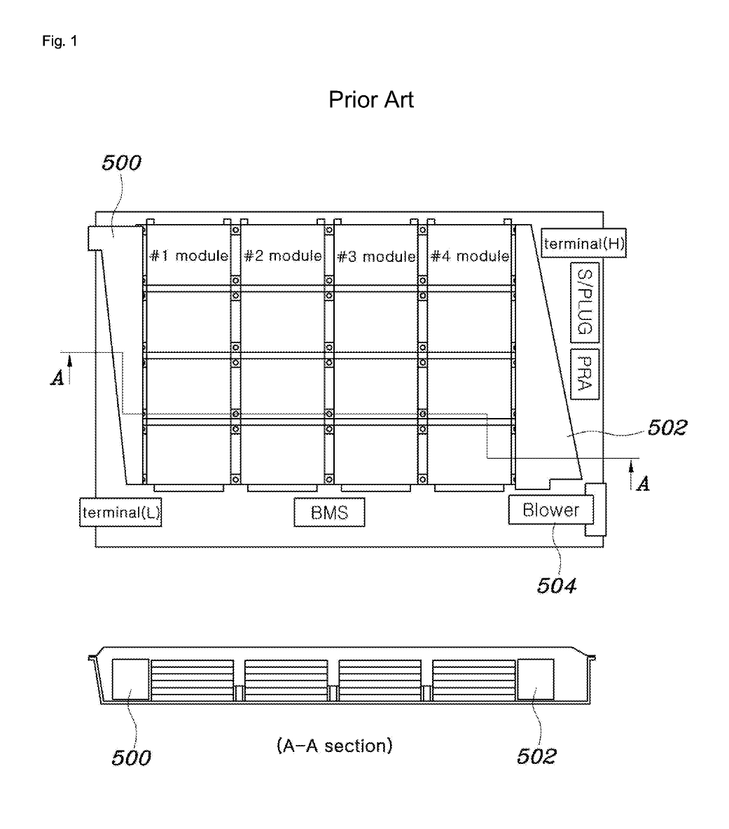

FIG. 2 is a view illustrating a battery cooling structure of a vehicle according to an exemplary embodiment of the present invention; and

FIG. 3 is a view illustrating the roof of a bus equipped with the battery cooling structure according to the exemplary embodiment present invention.

### DETAILED DESCRIPTION OF THE INVENTION

Reference will now be made in greater detail to a preferred embodiment of the invention while referring to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

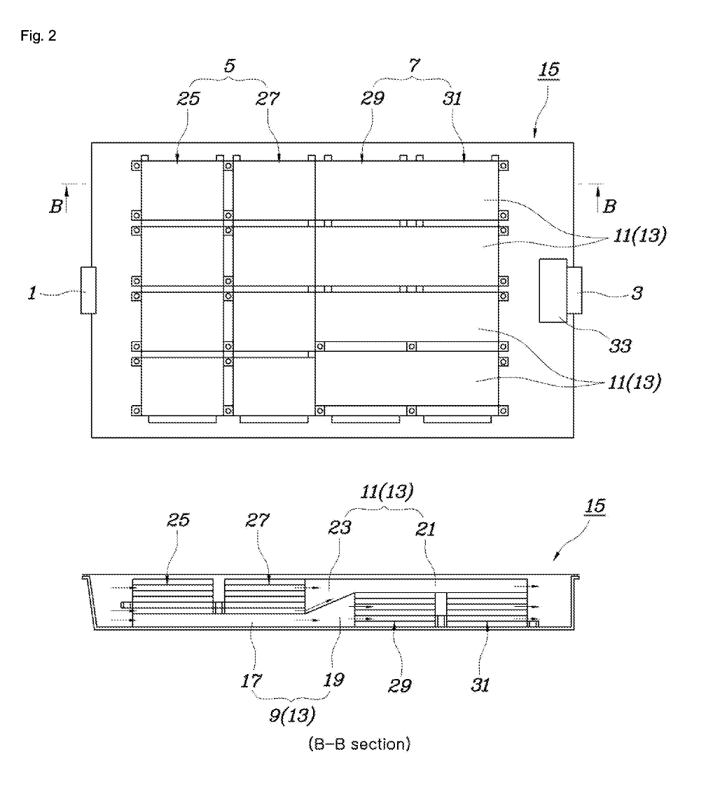

As shown in FIG. 2, a battery cooling structure of a vehicle according to an exemplary embodiment of the present invention includes: a first module group 5 and a second module group 7 arranged in a sequential row between an inlet 1 and an outlet 3 where each includes at least one battery module. More specifically, the first module group 5 is located relatively close to the inlet 1 and the second module group 7 is located relatively close to the outlet 3. A first duct 9 is arranged to guide air, which has flowed from the inlet 1 and has passed through the first module group 5 while cooling the first module group, to the outlet 3 after bypassing the second module group 7. A second duct 11 is arranged to guide air, which has flowed from the inlet 1 and has bypassed the first module group 5, to the second module group 7 so that the air can pass through the second module group 7 while cooling the second module group 7.

In other words, in the battery cooling structure in which a plurality of battery modules are arranged in sequential rows between the inlet 1 and the outlet 3, the first and second ducts 9 and 11 are at least two divided ducts 13 that are provided for guiding air flowing from the inlet 1 in such a way that the air can pass through one part of the plurality of battery modules to cooling them while at the same time bypassing another part of the battery modules to reach the outlet 3, so that the cool air flowing from the inlet 1 can be evenly distributed to all the battery modules constituting the battery pack 15, thereby avoiding inefficient cooling of some battery modules by heat-accumulated air.

The first duct 9 includes a first duct part 17 that is configured to guide air proceeding from the inlet 1 to the outlet 3. A first enlarged part 19 is connected to the first duct part 17 and enlarged in a cross-section proceeding towards the second module group 7 so that air, which has passed through the first duct part 17, can be guided to the second module group 7 effectively.

The second duct 11 includes a second duct part 21 that is configured to guide air proceeding from the inlet 1 to the outlet 3. A second enlarged part 23 is connected to the second duct part 21 and enlarged in a cross-section as it proceeds toward the first module group 7 so that air, which has passed through the first module group 5, can be guided to the second duct unit 21 effectively.

Further, in the illustrative embodiment, the first duct part 17 of the first duct 9 is placed at a location below the first module group 5, and the second duct part 21 of the second duct 11 is placed above the second module group 7. Further, the first enlarged part 19 and the second enlarged part 23 are arranged to be offset from each other at a junction between the first module group 5 and the second module group 7, thus increasing space efficiency of the structure.

In the embodiment, the first module group 5 includes a first battery module 25 and a second battery module 27, which are sequentially arranged proceeding from the inlet 1 to the outlet 3, and the second module group 7 includes a third battery module 29 and a fourth battery module 31, which are sequentially arranged proceeding from the inlet 1 to the outlet 3 at locations behind the second battery module 27. Here, the first enlarged part 19 and the second enlarged part 23 are offset from each other at a junction between the second battery module 27 and the third battery module 29.

The number of the first module group 5 and the number of the second module group 7 may be set to be different from each other, and the numbers of the divided ducts 13 may be increased to evenly cool an increased number of battery module groups according to the same manner as that described above.

In the battery cooling structure of the vehicle having the construction shown in FIG. 2, air introduced through the inlet 1 forms a first air current passing both through the first module group 5. Through the second duct 11 and a second air current passes both through the first duct 9 and through the second module group 7.

In other words, a part of the inlet air, which has been introduced into the battery pack 15 through the inlet 1 by operation of the blower 33, sequentially cools the first battery module 25 and the second battery module 27 constituting the first module group 5 after which it is discharged to the atmosphere through the outlet 3 after passing through the second duct 11, so that heat received from both the first battery module 25 and the second battery module 27 can be discharged to the outside of the battery pack 15 without influencing either of the third battery module 29 or the fourth battery module 31. On the other hand, another part of the inlet air, which has been introduced into the battery pack 15 through the inlet 1, passes through the first duct 9, so that it bypasses both the first battery module 25 and the second battery module 27 and, thereafter, sequentially cools the third battery module 29 and the fourth battery module 31 prior to being discharged to the atmosphere. Therefore, the third battery module 29 and the fourth battery module 31 can be efficiently cooled by air to realize the same cooling performance as that of the first battery module 25 and the second battery module 27.

As described above, the present invention is advantageous in that there remains no battery modules which are inefficiently cooled by air that has been previously used for cooling the remaining part of the battery modules constituting the battery pack 15, so that the present invention realizes uniform battery cooling performance and thereby improves the operational performance and durability of the battery pack 15.

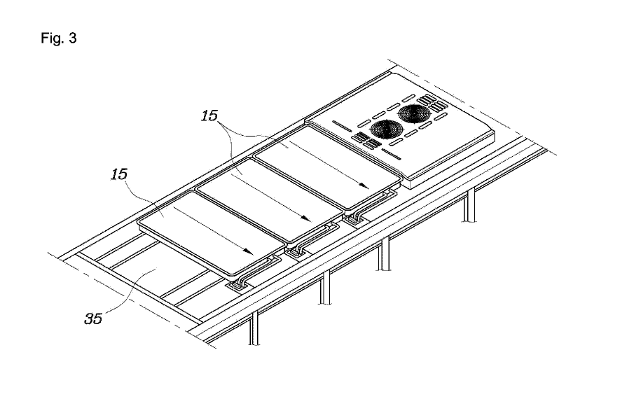

For reference, FIG. 3 illustrates an example of use in which a plurality of battery packs 15 of the present invention are installed on the roof 35 of a bus. As shown in the drawing, air can flow through the battery packs 15 in the directions shown by the arrows, thereby efficiently cooling the battery modules of the battery packs 15 prior to being discharged to the atmosphere. Here, it is preferred that the inlets 1 of the respective battery packs 15 be connected to each other by an air conduct so as to more efficiently cool the battery packs.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A battery cooling structure of a vehicle comprising:
a first module group and a second module group arranged in a row between an inlet and an outlet and each including at least one battery module, the first module group being located relatively near the inlet and the second module group being located relatively near the outlet;
a first duct arranged to guide air, which has flowed from the inlet and has passed through the first module group while cooling the first module group, to the outlet after bypassing the second module group; and
a second duct arranged to guide air, which has flowed from the inlet and has bypassed the first module group, to the second module group so that the air can pass through the second module group while cooling the second module group.

2. The battery cooling structure of the vehicle as set forth in claim 1, wherein
the first duct comprises: a first duct part configured to guide air proceeding from the inlet to the outlet; and a first enlarged part connected to the first duct part and enlarged in a cross-section proceeding toward the second module group so that air, which has passed through the first duct part, can be guided to the second module group, and
the second duct comprises: a second duct part configured to guide air proceeding from the inlet to the outlet; and a second enlarged part connected to the second duct part and enlarged in a cross-section proceeding toward the first module group so that air, which has passed through the first module group, can be guided to the second duct unit.

3. The battery cooling structure of the vehicle as set forth in claim 2, wherein
the first duct part of the first duct is disposed at a location below the first module group; and
the second duct part of the second duct is disposed above the second module group.

4. The battery cooling structure of the vehicle as set forth in claim 2, wherein the first enlarged part and the second enlarged part are arranged to be offset from each other at a junction between the first module group and the second module group.

5. The battery cooling structure of the vehicle as set forth in claim 2, wherein
the first module group comprises: a first battery module and a second battery module sequentially arranged proceeding from the inlet to the outlet, and
the second module group comprises: a third battery module and a fourth battery module sequentially arranged proceeding from the inlet to the outlet at locations behind the second battery module, wherein
the first enlarged part and the second enlarged part are offset from each other at a junction between the second battery module and the third battery module.

6. A battery cooling structure of a vehicle, comprising:
a plurality of battery modules arranged in rows between an inlet and an outlet; and
at least two divided ducts provided for guiding air flowing from the inlet in such a way that the air can pass through one part of the plurality of battery modules while cooling them and bypasses another part of the battery modules to reach the outlet.

7. The battery cooling structure of the vehicle as set forth in claim 6, wherein the divided ducts comprise:
a first duct for guiding air from the inlet to a battery module placed near the outlet after bypassing a battery module placed near the inlet; and
a second duct for guiding air, which has cooled the battery module placed near the inlet while passing through it, to the outlet after bypassing the battery module placed near the outlet.

8. A battery cooling structure of a vehicle comprising:
a first module group and a second module group arranged sequentially between an inlet and an outlet, wherein each module group includes at least one battery module;
a first duct arranged to guide air, which has flowed from the inlet and has passed through the first module group while cooling the first module group, to the outlet while bypassing the second module group; and
a second duct arranged to guide air, which has flowed from the inlet while bypassing the first module group, to the second module group so that the air can pass through the second module group while cooling the second module group.

9. The battery cooling structure of claim 8 wherein the first module group is disposed closer to the inlet than the second module group.

10. The battery cooling structure of the vehicle as set forth in claim 8, wherein
the first duct comprises: a first duct part configured to guide air proceeding from the inlet to the outlet; and a first enlarged part connected to the first duct part and enlarged in a cross-section proceeding toward the second module group so that air, which has passed through the first duct part, can be guided to the second module group, and
the second duct comprises: a second duct part configured to guide air proceeding from the inlet to the outlet; and a second enlarged part connected to the second duct part and enlarged in a cross-section proceeding toward the first module group so that air, which has passed through the first module group, can be guided to the second duct unit.

11. The battery cooling structure of the vehicle as set forth in claim 10, wherein
the first duct part of the first duct is disposed at a location below the first module group; and
the second duct part of the second duct is disposed above the second module group.

12. The battery cooling structure of the vehicle as set forth in claim 10, wherein the first enlarged part and the second enlarged part are arranged to be offset from each other at a junction between the first module group and the second module group.

13. The battery cooling structure of the vehicle as set forth in claim 10, wherein
the first module group comprises: a first battery module and a second battery module sequentially arranged proceeding from the inlet to the outlet, and
the second module group comprises: a third battery module and a fourth battery module sequentially arranged proceeding from the inlet to the outlet at locations behind the second battery module, wherein
the first enlarged part and the second enlarged part are offset from each other at a junction between the second battery module and the third battery module.
